(19) United States
(12) Patent Application Publication
(10) Pub. No.: US 2016/0139804 A1
(43) Pub. Date: May 19, 2016

(54) ELECTRONIC DEVICE AND METHOD FOR INPUTTING CHARACTERS USING THE ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Chih-Hua HSU, New Taipei (TW); Xiao-Ke MEI, Shenzhen (CN)

(21) Appl. No.: 14/814,712

(22) Filed: Jul. 31, 2015

(30) Foreign Application Priority Data
Nov. 14, 2014 (CN) 201410648176.8

(51) Int. Cl. G06F 3/0488; G06F 3/041

(52) U.S. Cl. CPC G06F 3/04886; G06F 3/0416

(57) ABSTRACT

A method for inputting characters into an electronic device by receiving proximity signals from proximity sensors. The proximity sensors include a first proximity sensor and at least one proximity sensor. Predetermined character types are displayed on the display device after enabling the proximity sensors. A character type from the predetermined character types is selected by receiving a proximity signal from the first proximity sensor, and a predetermined number of characters of the selected character type are displayed on the display device. Then, a character of the selected character type is input into the electronic device after receiving a proximity signal from the second proximity sensor.

### CROSS-REFERENCE TO RELATED APPLICATIONS

This application claims priority to Chinese Patent Application No. 201410648176.8 filed on Nov. 14, 2014, the contents of which are incorporated by reference herein.

### FIELD

The subject matter herein generally relates to electrical device control technology, and particularly to an electronic device and a method for inputting characters using the electronic device.

### BACKGROUND

An input interface of an electronic device (for example, a mobile phone) can be a physical keyboard or a virtual keyboard. The physical keyboard occupies space on the front of the electronic device, and the virtual keyboard occupies a substantially portion of the input interface.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a block diagram of an example embodiment of function modules of an inputting system.

FIG. 3 is diagrammatic view of an example embodiment of character types displayed on the electronic device.

FIG. 4 is a diagrammatic view of an example embodiment of letters displayed on the electronic device.

FIG. 5 is a diagrammatic view of an example embodiment of numbers displayed on the electronic device.

FIG. 6 is a diagrammatic view of an example embodiment of punctuation marks displayed on the electronic device.

FIG. 7 is a flowchart of an example embodiment of a method for inputting characters into the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

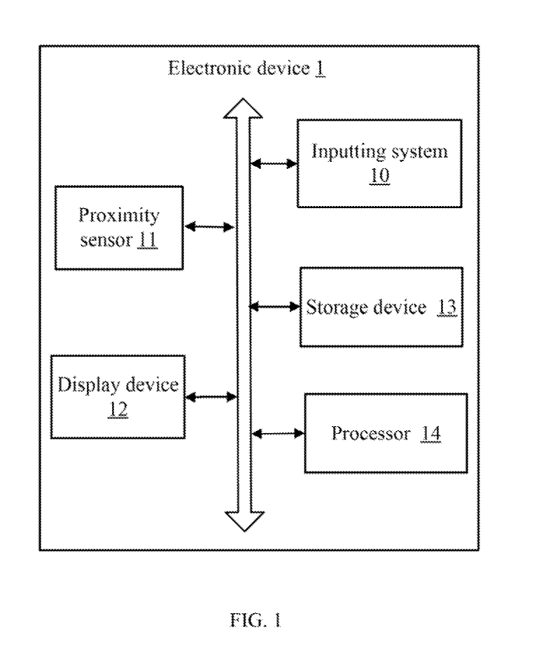

FIG. 1 is a block diagram of an example embodiment of an electronic device. In at least one embodiment as shown in FIG. 1, an electronic device 1 includes an inputting system 10. The electronic device 1 can be a smart phone, a personal digital assistant (PDA), a tablet computer, or any other suitable electronic device. The electronic device 1 further includes, but is not limited to, proximity sensors 11, a display device 12, a storage device 13, and at least one processor 14. The proximity sensors 11, the display device 12, and the storage device 13, coupled to the at least one processor 14. FIG. 1 illustrates only one example of the electronic device, other examples can include more or fewer components than illustrated, or have a different configuration of the various components in other embodiments.

In at least one embodiment, the proximity sensors 11 can detect a presence of a nearby object, such as a finger of a user, by emitting a beam of electromagnetic radiation (for example, infrared), and receive the beam of electromagnetic radiation returning from the nearby object. When receiving the beam of electromagnetic radiation returning from the nearby object, the proximity sensors 11 can generate a proximity signal, and transmit the proximity signal to the electronic device 1.

In at least one embodiment, the proximity sensors 11 can be equipped on borders around the electronic device 1, and the number of the equipped proximity sensors 11 can be ten. In at least one embodiment, the proximity sensors 11 can include a first proximity sensor and at least one second proximity sensor. The first proximity sensor 11 is the first one of the proximity sensors 11 which transmits a proximity signal to the inputting system 10, and the second proximity sensor 11 is any one of the proximity sensors 11 except the first proximity sensor 11.

All of the ten proximity sensors 11 can be equipped between the borders around the electronic device 1 and the borders around the display device 12. For example, three proximity sensors 11 are equipped on the top border, three proximity sensors 11 are equipped on the bottom border, two proximity sensors 11 are equipped on the left border, and two proximity sensors 11 are equipped on the right border. In at least one embodiment, the number of the proximity sensor 11 can be two, three, four, five, six, seven, eight, nine or more than ten.

The display device 12 can show words and graphical interfaces. In one embodiment, the display can be a flat panel display, such as a liquid crystal display (LCD), a plasma screen, or an organic light emitting diode display (OLED) screen.

In at least one embodiment, the storage device 13 can include various types of non-transitory computer-readable storage mediums. For example, the storage device 14 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium. In at least one embodiment, the at least one processor 14 can be a central processing unit (CPU), a microprocessor, or other data processor chip that performs functions of the electronic device 1. In one embodiment, the storage device 13 can store a map between types of characters and the proximity sensors 11, and a map between characters and the proximity sensors 11.

The inputting system 10 can select a character type that needs to be input into the electronic device 1, and input characters of a selected character type according to the proximity signals transmitted from the proximity sensors 11.

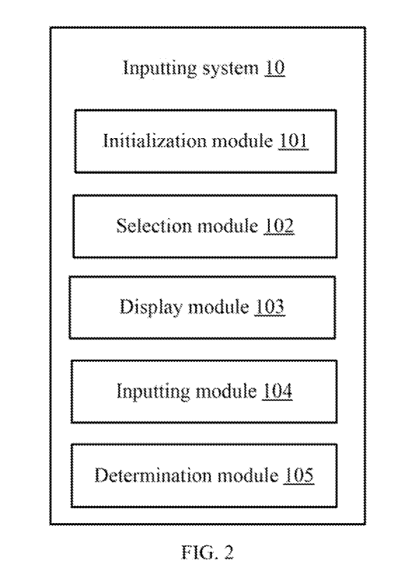

FIG. 2 is a block diagram of one embodiment of function modules of the inputting system. In at least one embodiment, the inputting system 10 can include an initialization module 101, a selection module 102, a display module 103, an inputting module 104, and a determination module 105. The function modules 101, 102, 103, 104, and 105 can include computerized codes in the form of one or more programs which are stored in the storage device 13. The at least one processor 14 executes the computerized codes to provide functions of the function modules 101-105.

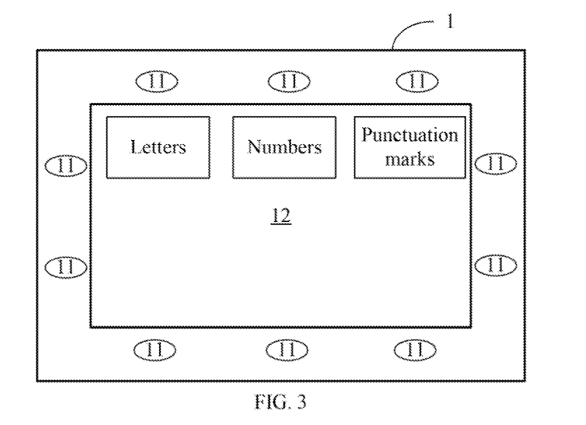

The initialization module 101 can enable the proximity sensors 11, and display predetermined character types on the display device 12. In at least one embodiment, when a user needs to input characters into the electronic device 1, the initialization module can enable the proximity sensors 11. For example, when the user needs to text a message, the proximity sensors 11 are enabled by the initialization module 101 for the user to input characters. As shown in FIG. 3, the predetermined character types include letters, numbers, and punctuation marks.

The selection module 102 can select a character type from the predetermined character types by receiving a proximity signal from the first proximity sensor. In at least one embodiment, when the first proximity sensor detects a presence of a nearby object, the first proximity sensor can generate a proximity signal, and transmit the proximity signal to the selection module 102. Thus, the selection module 102 can receive the proximity signal, and select the character type corresponding to the first proximity sensor.

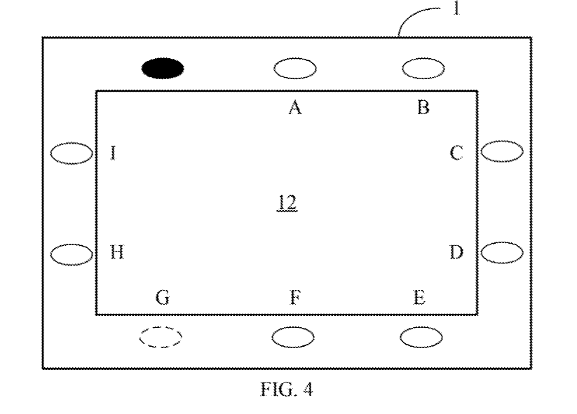

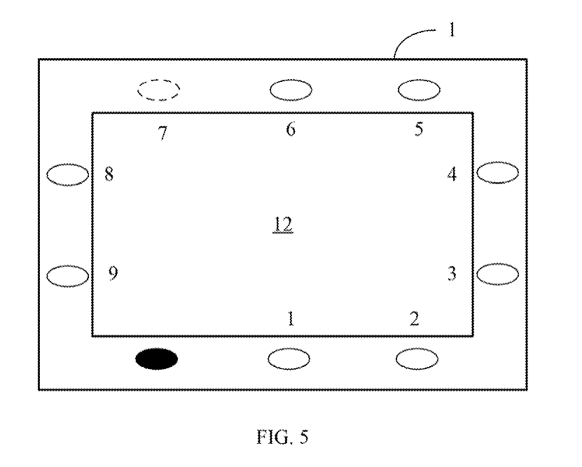

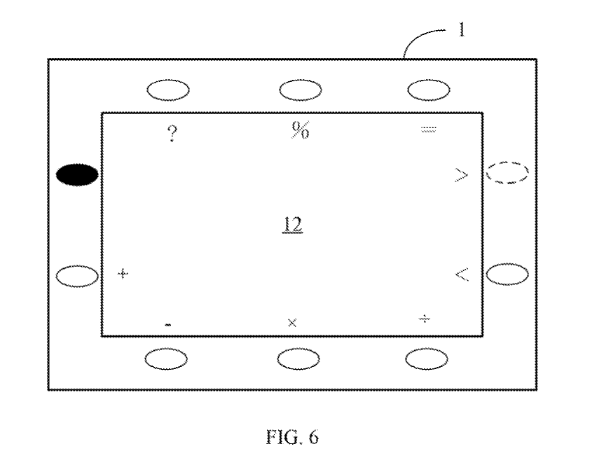

In at least one embodiment, when the first proximity sensor, as shown in solid black oval shape in FIG. 4, detects the presence of the nearby object, a corresponding character type can be selected. For example, a selected character type is a letter. When the first proximity sensor, as shown in solid black oval shape in FIG. 5, detects the presence of the nearby object, a corresponding character type can be selected. For example, a selected character type is a number. When the first proximity sensor as shown in solid black oval shape in FIG. 6, detects the presence of the nearby object, a corresponding character type can be selected. For example, a selected character type is a punctuation mark.

The display module 103 can display a predetermined number of characters of the selected character type on the display device 12. In at least one embodiment, the predetermined number of the characters is equal to the number of the second proximity sensors. For example, as shown in FIG. 4, when the selected character type is a letter, the display module 103 can display letters “A, B, C, D, E, F, G, H, I” on the display device 12. In one embodiment, as shown in FIG. 5, when the selected character type is a number, the display module 103 can display numbers “1, 2, 3, 4, 5, 6, 7, 8, 9” on the display device 12. In one embodiment, as shown in FIG. 6, when the selected character type is a punctuation mark, the display module 103 can display punctuation marks “+, −, x, ÷, <, >, =, %, ?” on the display device 12.

In at least one embodiment, when the first proximity sensor 11 detects the nearby object again, the display module 103 can display the predetermined number of other characters of the selected character type on the display device 12. For example, when the selected character is a letter, and the first proximity sensor 11 detects the nearby object again, the display module 103 can display “J, K, L, M, N, O, P, Q, R” on the display device 12. When the selected character is a punctuation mark, and the first proximity sensor 11 detects the nearby object again, the display module 103 can display “!, @, #, $, ̂, &, *, (,)” on the display device 12.

The inputting module 104 can input a character of the selected character type after receiving the proximity signal from the second proximity sensor. In at least one embodiment, when the second proximity detects the nearby object, the second proximity sensor can generate a proximity signal and transmit the proximity signal to the inputting module 104. Thus, the inputting module 104 can receive the proximity signal, and input a character of the selected character type.

For example, the inputting module 104 can input a letter “G” after receiving the proximity signal from the second proximity sensor, as shown in FIG. 4. The inputting module 104 can input a number “7” after receiving the proximity signal from the second proximity sensor, and the second proximity sensor is shown in dotted oval shape in FIG. 5. The inputting module 104 can input a punctuation mark “>” after receiving the proximity signal from the second proximity sensor, and the second proximity sensor is shown in dotted oval shape in FIG. 6.

The determination module 105 can determine whether the characters are input into the electronic device 1. In at least one embodiment, the determination module 105 can detect whether the proximity sensors 11 transmit proximity signals to the electronic device 1 during predetermined time duration (for example, five seconds). When one of the proximity sensors 11 transmits a proximity signal to the electronic device 1 during the predetermined time duration, it can be determined that the characters are not input into the electronic device 1. When none of the proximity sensors 11 transmits the proximity signal to the electronic device 1 during the predetermined time duration, it can be determined that the characters are input into the electronic device 1.

When the characters are input into the electronic device 1, the determination module 105 can disable the proximity sensors 11.

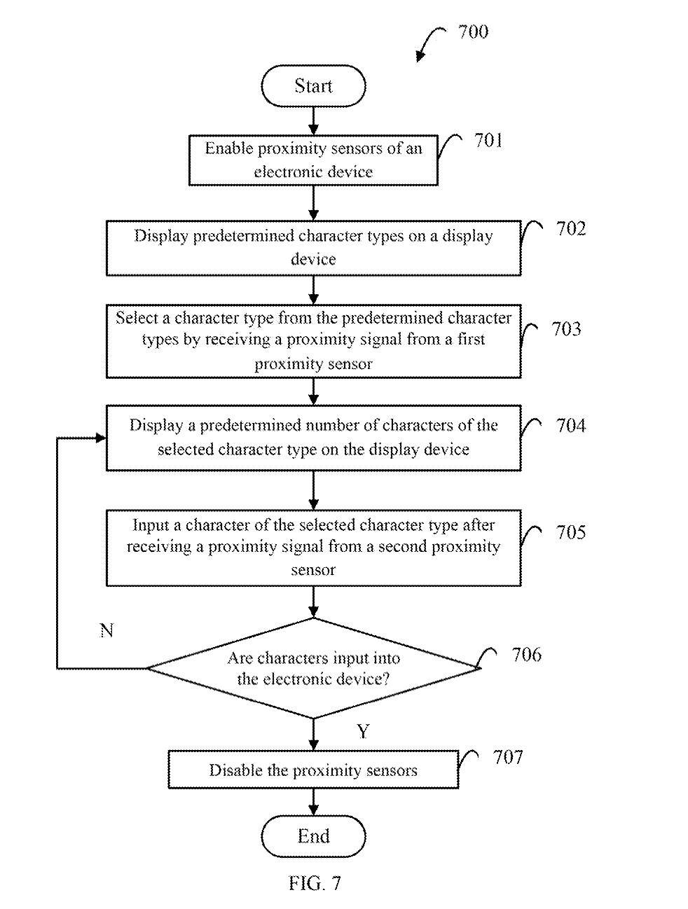

FIG. 7 illustrates a flowchart is presented in accordance with an example embodiment. An example method 700 is provided by way of example, as there are a variety of ways to carry out the method. The example method 700 described below can be carried out using the configurations illustrated in FIG. 1 and FIG. 2, and various elements of these figures are referenced in explaining the example method. Each block shown in FIG. 7 represents one or more processes, methods, or subroutines, carried out in the example method 700. Furthermore, the illustrated order of blocks is illustrative only and the order of the blocks can be changed according to the present disclosure. The example method 700 can begin at block 701. Depending on the embodiment, additional blocks can be utilized and the ordering of the blocks can be changed.

At block 701, an initialization module can enable the proximity sensors. In at least one embodiment, when a user needs to input characters into the electronic device, the initialization module can enable the proximity sensors. For example, when the user needs to text a message, the initialization module enables the proximity sensors for the user to input characters.

At block 702, the initialization module can display predetermined character types on a display device of the electronic device. In at least one embodiment, as shown in FIG. 3, the predetermined character types include letters, numbers, and punctuation marks.

At block 703, a selection module can select a character type from the predetermined character types by receiving a proximity signal from the first proximity sensor. In at least one embodiment, when the first proximity sensor detects a presence of a nearby object, the first proximity sensor can generate a proximity signal, and transmit the proximity signal to the selection module. Thus, the selection module can receive the proximity signal, and select the character type corresponding to the first proximity sensor.

In at least one embodiment, when the first proximity sensor, as shown in solid black oval shape in FIG. 4, detects the presence of the nearby object, a corresponding character type can be selected. For example, a selected character type is a letter. When the first proximity sensor, as shown in solid black oval shape in FIG. 5, detects the presence of the nearby object, a corresponding character type can be selected. For example, a selected character type is a number. When the first proximity sensor as shown in solid black oval shape in FIG. 6, detects the presence of the nearby object, a corresponding character type can be selected. For example, a selected character type is a punctuation mark.

At block 704, a display module can display a predetermined number of characters of the selected character type on the display device. In at least one embodiment, the predetermined number of the characters is equal to the number of the second proximity sensors. For example, as shown in FIG. 4, when the selected character type is a letter, the display module can display letters “A, B, C, D, E, F, G, H, I” on the display device. In one embodiment, as shown in FIG. 5, when the selected character type is a number, the display module can display numbers “1, 2, 3, 4, 5, 6, 7, 8, 9” on the display device. In one embodiment, as shown in FIG. 6, when the selected character type is a punctuation mark, the display module can display punctuation marks “+, −, x, ÷, <, >, =, %, ?” on the display device.

In at least one embodiment, when the first proximity sensor detects the nearby object again, the display module can display the predetermined number of other characters of the selected character type on the display device. For example, when the selected character is a letter, and the first proximity sensor detects the nearby object again, the display module can display “J, K, L, M, N, O, P, Q, R” on the display device. When the selected character is a punctuation mark, and the first proximity sensor detects the nearby object again, the display module can display “!, @, #, $, ̂, &, *, (,)” on the display device.

At block 705, an inputting module can input a character of the selected character type after receiving the proximity signal from the second proximity sensor. In at least one embodiment, when the second proximity detects the nearby object, the second proximity sensor can generate a proximity signal, and transmit the proximity signal to the inputting module. Thus, the inputting module can receive the proximity signal, and input a character of the selected character type.

For example, the inputting module can input the letter “G” after receiving the proximity signal from the second proximity sensor, as shown in FIG. 4. The inputting module can input the number “7” after receiving the proximity signal from the second proximity sensor, and the second proximity sensor is shown in dotted oval shape in FIG. 5. The inputting module can input a punctuation mark “>” after receiving the proximity signal from the second proximity sensor, and the second proximity sensor is shown in dotted oval shape in FIG. 6.

At block 706, a determination module can determine whether the characters are input into the electronic device. In at least one embodiment, the determination module can detect whether the proximity sensors transmit proximity signals to the electronic device during predetermined time duration (for example, five seconds). When one of the proximity sensors transmits a proximity signal to the electronic device during the predetermined time duration, it can be determined that the characters are not input into the electronic device, the procedure goes to block 707. When the proximity signal is not transmitted by the proximity sensors to the electronic device during the predetermined time duration, it can be determined that the characters are input into the electronic device, the procedure returns to block 704.

When the characters are input into the electronic device, at block 707, the inputting module can disable the proximity sensors.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
proximity sensors comprising a first proximity sensor and at least one second proximity sensor;
at least one processor coupled to the proximity sensors;
a display device coupled to the at least one processor; and
a storage device coupled to the at least one processor;
wherein the storage device stores one or more programs, executable by the at least one processor, to cause the at least one processor to:
enable the proximity sensors;
display predetermined character types on the display device;
select a character type from the predetermined character types by receiving a proximity signal from the first proximity sensor;
display a predetermined number of characters of the selected character type on the display device; and
input a character of the selected character type after receiving a proximity signal from the second proximity sensor.

2. The electronic device according to claim 1, wherein the at least one processor further:
determines whether the characters are input into the electronic device; and
disables the proximity sensors when the characters are input into the electronic device.

3. The electronic device according to claim 1, wherein the predetermined character types comprising letters, numbers, and punctuation marks.

4. The electronic device according to claim 1, wherein the predetermined number of characters of the current type is equal to the number of the second proximity sensors.

5. The electronic device according to claim 1, wherein the proximity sensors are equipped on the borders of the electronic device.

6. The electronic device according to claim 1, wherein the first proximity sensor is the first one of the proximity sensors which transmits a proximity signal to the electronic device, and the second proximity sensor is any one of the proximity sensors except the first proximity sensor.

7. A non-transitory storage medium having stored thereon instructions that, when executed by a processor of an electronic device, the electronic device comprising proximity sensors, the proximity sensors comprising a first proximity sensor and at least one second proximity sensor, causes the processor to perform an inputting method using the electronic device, the method comprising:
enabling the proximity sensors;
displaying predetermined character types on a display device of an electronic device;
selecting a character type from the predetermined character types by receiving a proximity signal from the first proximity sensor;
displaying a predetermined number of characters of the selected character type on the display device; and
inputting a character of the selected character type after receiving a proximity signal from the second proximity sensor.

8. The method according to claim 7, further comprising:
determining whether the characters are input into the electronic device; and
disabling the proximity sensors when the characters are input into the electronic device.

9. The method according to claim 7, wherein the predetermined character types comprising letters, numbers, and punctuation marks.

10. The method according to claim 7, wherein the predetermined number of characters of the current type is equal to the number of the second proximity sensors.

11. The method according to claim 7, wherein the proximity sensors are equipped on the borders of the electronic device.

12. The method according to claim 7, wherein the first proximity sensor is the first one of the proximity sensors which transmits a proximity signal to the electronic device, and the second proximity sensor is any one of the proximity sensors except the first proximity sensor.

13. A non-transitory storage medium having stored thereon instructions that, when executed by a processor of an electronic device, the electronic device comprising proximity sensors, the proximity sensors comprising a first proximity sensor and at least one second proximity sensor, causes the processor to perform an inputting method using the electronic device, the method comprising:
enabling the proximity sensors;
displaying predetermined character types on a display device of an electronic device;
selecting a character type from the predetermined character types by receiving a proximity signal from the first proximity sensor;
displaying a predetermined number of characters of the selected character type on the display device; and
inputting a character of the selected character type after receiving a proximity signal from the second proximity sensor.

14. The non-transitory storage medium according to claim 13, wherein the method further comprises:
determining whether the characters are input into the electronic device; and
disabling the proximity sensors when the characters are input into the electronic device.

15. The non-transitory storage medium according to claim 13, wherein the predetermined character types comprising letters, numbers, and punctuation marks.

16. The non-transitory storage medium according to claim 13, wherein the predetermined number of characters of the current type is equal to the number of the second proximity sensors.

17. The non-transitory storage medium according to claim 13, wherein the proximity sensors are equipped on the borders of the electronic device.

18. The non-transitory storage medium according to claim 13, wherein the first proximity sensor is the first one of the proximity sensors which transmits a proximity signal to the electronic device, and the second proximity sensor is any one of the proximity sensors except the first proximity sensor.
